(19) United States
(12) Patent Application Publication
(10) Pub. No.: US 2022/0084048 A1
(43) Pub. Date: Mar. 17, 2022

(54) SERVER APPARATUS, METHOD OF CONTROLLING SERVER APPARATUS, COMPUTER-READABLE MEDIUM, GENUINE PRODUCT DETERMINING SYSTEM, AND METHOD OF CONTROLLING GENUINE PRODUCT DETERMINING SYSTEM

(71) Applicants: CANON MARKETING JAPAN KABUSHIKI KAISHA, Tokyo (JP); CANON IT SOLUTIONS KABUSHIKI KAISHA, Tokyo (JP)

(72) Inventor: Hiroyasu ABE, Tokyo (JP)

(21) Appl. No.: 17/538,454

(22) Filed: Nov. 30, 2021

Related U.S. Application Data
(63) Continuation of application No. PCT/JP2020/021560, filed on Jun. 1, 2020.

(30) Foreign Application Priority Data
Jun. 5, 2019 (JP) 2019-104961

(51) Int. Cl. G06Q 30/00; G09F 3/00; H04W 4/021

(52) U.S. Cl. CPC G06Q 30/0185; G09F 2003/0277; H04W 4/021; G09F 3/0297

(57) ABSTRACT

A server apparatus is provided that includes: at least one memory and at least one processor which function as: a first obtaining unit configured to obtain identification information about a product from a terminal apparatus; a determining unit configured to determine whether the obtained identification information is included in genuine product information including identification information about a genuine product; a second obtaining unit configured to obtain, from the terminal apparatus, personal information from which a user of the terminal apparatus is identifiable; an anonymizing unit configured to anonymize the obtained personal information; and a registering unit configured to register the obtained identification information, a determination result output as a result of the determination, and the anonymized personal information in a storage unit so that the determination result and the anonymized personal information are associated with the obtained identification information.

### CROSS-REFERENCE TO RELATED APPLICATIONS

This application is a Continuation of International Patent Application No. PCT/JP2020/021560, filed Jun. 1, 2020, which claims the benefit of Japanese Patent Application No. 2019-104961, filed Jun. 5, 2019, both of which are hereby incorporated by reference herein in their entirety.

### BACKGROUND OF THE INVENTION

### Field of the Invention

The present invention relates to a server apparatus, a method of controlling a server apparatus, a computer-readable medium, a genuine product determining system, and a method of controlling a genuine product determining system.

### Description of the Related Art

In recent years, counterfeit commercial products sometimes infiltrate the market. Companies manufacturing or selling commercial products therefore provide services for checking whether a commercial product is a counterfeit product to purchasers. An example thereof is Japanese Patent Application Laid-Open No. 2008-293284. In Japanese Patent Application Laid-Open No. 2008-293284, there is disclosed a system for determining whether a commercial product is a counterfeit product. In the system, a purchaser of the commercial product uses a terminal apparatus to read a unique two-dimensional code printed on a packaging material.

In a case of the system disclosed in Japanese Patent Application Laid-Open No. 2008-293284 and similar systems, information about commercial products that are not a genuine commercial product is often provided to companies manufacturing and selling the genuine commercial product. This information is, for example, information of a location at which a determination request for determining whether a commercial product is genuine has been issued, and information for identifying a terminal apparatus that has issued the determination request. However, this kind of information has a possibility of being used as information from which an individual can be identified, depending on what laws or regulations are set. A resultant problem is that an administrator of a server apparatus on which whether a commercial product is genuine is determined is required to properly manage those pieces of information.

### SUMMARY OF THE INVENTION

An object of at least one embodiment of the present invention is to lighten a burden of managing personal information obtained in determination about whether a product is a genuine product.

A server apparatus according to the present invention has the following configuration. That is, the server apparatus includes: at least one memory and at least one processor which function as: a first obtaining unit configured to obtain identification information about a product from a terminal apparatus; a determining unit configured to determine whether the obtained identification information is included in genuine product information including identification information about a genuine product; a second obtaining unit configured to obtain, from the terminal apparatus, personal information from which a user of the terminal apparatus is identifiable; an anonymizing unit configured to anonymize the obtained personal information; and a registering unit configured to register the obtained identification information, a determination result output as a result of the determination, and the anonymized personal information in a storage unit so that the determination result and the anonymized personal information are associated with the obtained identification information.

Further features of the present invention will become apparent from the following description of exemplary embodiments with reference to the attached drawings.

### BRIEF DESCRIPTION OF THE DRAWINGS

FIG. 1 is a diagram for illustrating an example of a system configuration according to a first embodiment.

FIG. 2 is a diagram for illustrating an example of a hardware configuration of a portable terminal in the first embodiment.

FIG. 3 is a diagram for illustrating an example of a hardware configuration of a client terminal and a genuine product determining server according to the first embodiment.

FIG. 4 is a diagram for illustrating an example of a utilization mode in the first embodiment.

FIG. 5 is a diagram for illustrating an example of a function configuration in the first embodiment.

FIG. 6 is a diagram for illustrating an example of a flow chart of setting processing in the first embodiment.

FIG. 7 is a diagram for illustrating an example of a genuine product determining condition setting screen in the first embodiment.

FIG. 8 is a group of tables for showing an example of various types of data in the first embodiment.

FIG. 9 is a diagram for illustrating an example of a flow chart of genuine product determining processing in the first embodiment.

FIG. 10 is a diagram for illustrating an example of a flow chart of genuine product determining processing in a modification example of the first embodiment.

FIG. 11 is a diagram for illustrating an example of a function configuration in a second embodiment.

FIG. 12A is a diagram for illustrating an example of a genuine product determining condition setting screen in the second embodiment.

FIG. 12B is a table for showing an example of settings information in the second embodiment.

FIG. 13 is a diagram for illustrating an example of a flow chart of genuine product determining processing in the second embodiment.

### DESCRIPTION OF THE EMBODIMENTS

Exemplary embodiments for carrying out the present invention is described in detail below with reference to the drawings. However, the scope of the present invention is not limited to the examples illustrated in the drawings.

### First Embodiment

An outline of a first embodiment is described first. A genuine product determining server according to the first embodiment is an apparatus for determining whether a product is genuine. This determination is hereinafter referred to as “genuine product determination.” A product that is genuine is referred to as “genuine product,” and a product that is not genuine is referred to as “non-genuine product.”

The genuine product determining server obtains, as information from which a user owning a portable terminal that has issued a request for genuine product determination is identifiable (personal information), position information indicating a current position of the portable terminal and an IP address. The genuine product determining server anonymizes the obtained personal information by partial modification so that the user is unidentifiable from the personal information. For example, the genuine product determining server rounds the position information down to two decimal places, or substitutes a fourth octet of the IP address with 0. The genuine product determining server then registers identification information of a product used in the genuine product determination, a result of the genuine product determination, and the modified personal information in a storage unit in association with one another.

Identification of an individual from the obtained personal information is prevented in this manner, and a burden of managing personal information on an administrator of the genuine product determining server can accordingly be lightened. In addition, with the personal information modified only partially, a company that is a user of a genuine product determining system can identify a general location of the portable terminal for which the genuine product determination has been executed from the modified position information. From the modified IP address, a distributor can find out a country and a region in which the genuine product determination has been executed, a person to which the IP address is assigned, an Internet communication service provider, and other types of information.

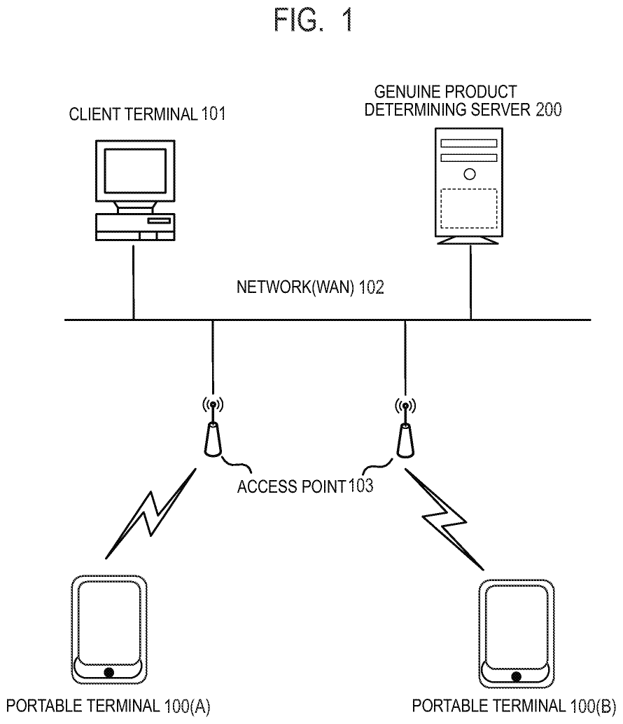

A configuration and processing of the first embodiment are described below with reference to FIG. 1 to FIG. 9.

[System Configuration]

FIG. 1 is a diagram for illustrating an example of a system configuration of the genuine product determining system (information processing system). The genuine product determining system includes a portable terminal 100(A), a portable terminal 100(B), a client terminal 101, and a genuine product determining server 200. Those apparatus are connected to one another via a network 102 (a WAN or a LAN) in a manner that allows data communication between the apparatus. In the following description, each of the portable terminal 100(A) and the portable terminal 100(B) is referred to as “portable terminal 100” when discrimination between the portable terminal 100(A) and the portable terminal 100(B) is not required. The configuration of FIG. 1 in which various terminals and the server that are connected to the network are illustrated is an example, and it goes without saying that there are various configuration examples to suit uses or purposes.

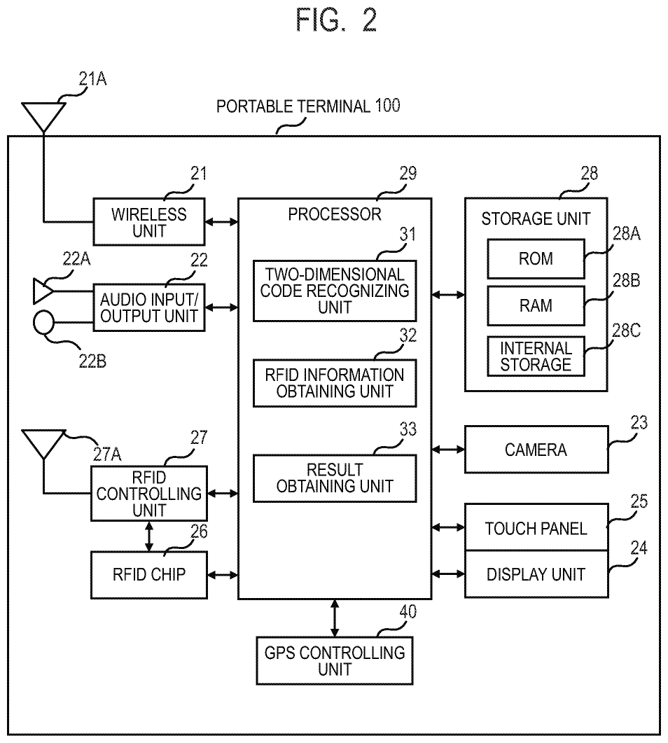

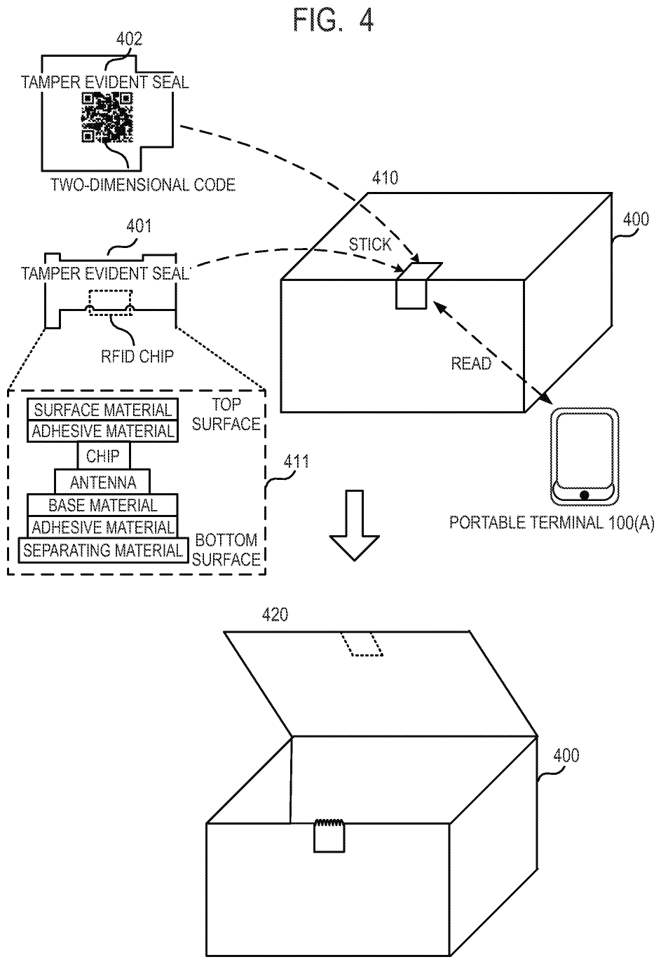

The portable terminal 100 is a terminal apparatus that can hold communication to and from access points 103 capable of wireless communication. The access points 103 may be base stations of cellular phone networks. The portable terminal 100 can read, via an RFID antenna 27A (FIG. 2) of the portable terminal 100, an RFID chip (contactless tag) included in a tamper evident seal 401, which is stuck to a box 400 illustrated in FIG. 4. The portable terminal 100 can also read a two-dimensional code printed on a tamper evident seal 402 illustrated in FIG. 4 with a camera of the portable terminal 100. The portable terminal 100 obtain, through those reading processing procedures, from the two-dimensional code or the RFID chip, a unique ID (identification information) to be used in the genuine product determination, and transmit the unique ID to the genuine product determining server 200.

In the first embodiment, “box” is an outer package covering a product. The tamper evident seals 401 and 402 are an example of reading targets stuck to an exterior of an outer package. The tamper evident seal 401 and the tamper evident seal 402 may be rephrased as a first reading target and a second reading target, respectively.

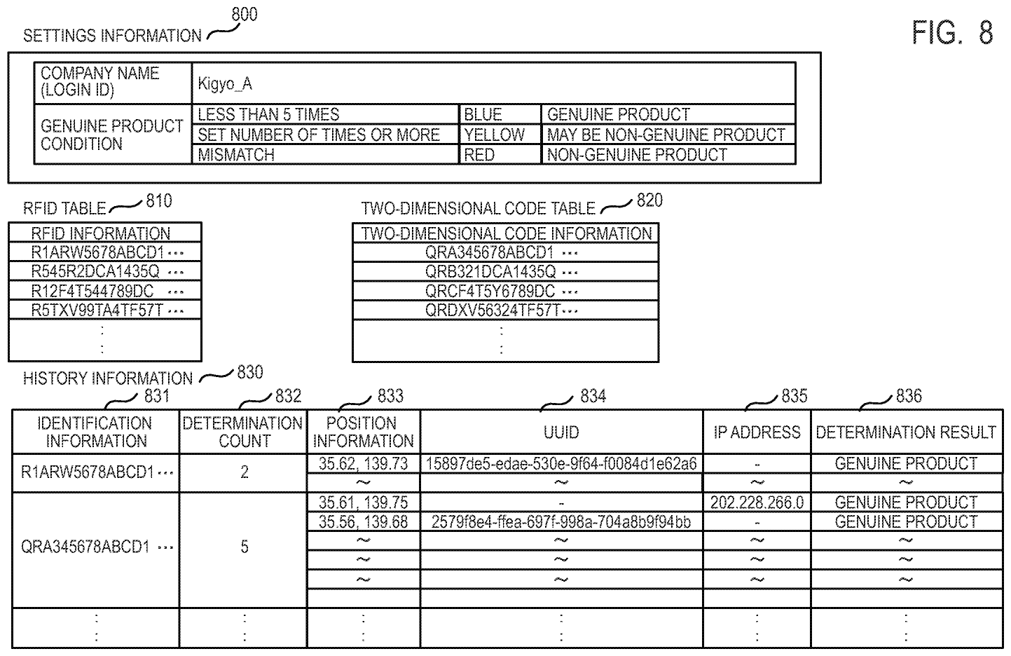

The genuine product determining server 200 is a server apparatus which executes the genuine product determination with the use of the identification information received from the portable terminal 100, and transmits results of the determination to the portable terminal 100. The genuine product determining server 200 in the first embodiment may be a general-purpose computer similar to the client terminal. The genuine product determining server 200 stores various types of data (for example, FIG. 8). The various types of data may be managed in a database. The genuine product determining server 200 may be a server apparatus on a cloud network. That is, the genuine product determining server 200 may be a single virtual server or a plurality of virtual servers booted on a single or a plurality of server apparatus by virtualization technology.

The client terminal 101 is a terminal apparatus to be used by the administrator. The client terminal 101 holds communication to and from the genuine product determining server 200 to receive input of settings information to be used in the genuine product determination.

[Hardware Configuration]

FIG. 2 is a diagram for illustrating an example of a hardware configuration of the portable terminal 100 in the first embodiment.

The portable terminal 100 corresponds to, for example, cellular phone, smartphone, and other wireless terminal. The portable terminal 100 includes a wireless unit 21, an audio input/output unit 22, a camera 23, a display unit 24, a touch panel 25, an RFID chip 26, an RFID controlling unit 27, a storage unit 28, a processor 29, and a GPS controlling unit 40.

The wireless unit 21 is a communication interface connected to a wireless antenna 21A to handle wireless communication to and from a wireless communication network via one of the access points 103. The audio input/output unit 22 is an interface connected to a speaker 22A and a microphone 22B to input/output audio.

The camera 23 has a function of picking up a moving image, a still image, and other images. That is, the camera 23 is a photographing unit which takes a photograph of the two-dimensional code in the first embodiment. The display unit 24 is an output interface on which information of various types is displayed. The display unit 24 corresponds to, for example, a display. The touch panel 25 is an input interface through which touch operation performed on the display unit 24 is detected. The RFID chip 26 is a semiconductor chip related to RFID. The RFID controlling unit 27 is connected to the RFID antenna 27A to obtain an ID of the RFID chip (including an antenna) of the tamper evident seal 401 in response to a carrier wave from the RFID chip.

The storage unit 28 includes a read-only memory (ROM) 28A, a random access memory (RAM) 28B, and an internal storage 28C. The ROM 28A stores, for example, an operating system and various programs. The ROM 28A also stores an individual identification number of the portable terminal 100. The RAM 28B is a storage medium for temporarily storing various types of information. The internal storage 28C is a storage medium that is a hard disk drive or the like, and stores an application file, a document file, an image file, and other types of data. The internal storage 28C may be a card-type storage medium that is an SD card or the like.

The processor 29 is a component which performs overall control of the portable terminal 100 and is, for example, a CPU. The processor 29 reads out a program stored in the ROM 28A, and implements various processes based on the read program.

The processor 29 functions as a two-dimensional code recognizing unit 31, an RFID information obtaining unit 32, and a result obtaining unit 33. The two-dimensional code recognizing unit 31 uses a zoom function and an auto focus function of the camera 23 to read a two-dimensional code and perform image recognition. The two-dimensional code recognizing unit 31 then obtains a unique ID (identification information) obtained from a result of the image recognition. The obtained identification information is transmitted to the genuine product determining server 200.

The RFID information obtaining unit 32 obtains, via the RFID controlling unit 27, a unique ID (identification information) read from the RFID chip of the tamper evident seal 401. The obtained identification information is transmitted to the genuine product determining server 200.

The RFID controlling unit 27 connects to the RFID antenna 27A, and uses a carrier wave for reading detection output from the RFID antenna 27A to read identification information from the RFID chip of the tamper evident seal 401 through communication to and from the RFID chip. The carrier wave is a signal for reading detection that uses a high-frequency (HF) frequency band. The RFID antenna 27A transmits the carrier wave in an RFID communication range at a predetermined transmission distance from a reading area. The RFID controlling unit 27 further uses the carrier wave to read information from an RFID chip in the tamper evident seal 401 located inside an RFID reading range, which is within the RFID communication range, through communication to and from the RFID chip. A desired RFID reading range is approximately within 2 cm.

The portable terminal 100 receives a result of the genuine product determination from the genuine product determining server 200 via the wireless unit 21. The result obtaining unit 33 obtains the received result and displays the obtained result on the display unit 24.

The GPS controlling unit 40 is a controlling unit which obtains position information obtained from a GPS antenna (not shown).

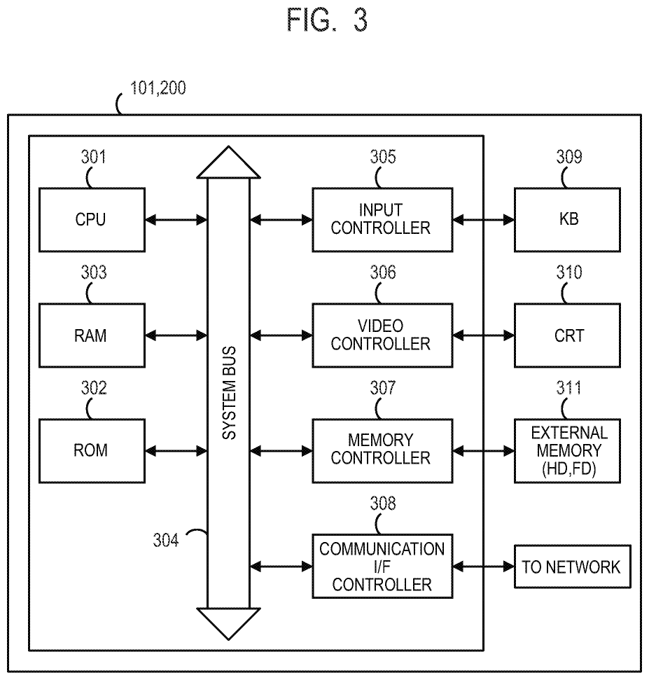

FIG. 3 is a diagram for illustrating an example of a hardware configuration of the client terminal 101 and the genuine product determining server 200 in embodiments of the present invention.

A CPU 301 performs overall control of devices and controllers connected to a system bus 304.

A ROM 302 or an external memory 311 (a storage unit) stores a Basic Input/Output System (BIOS), which is a control program of the CPU 301. The ROM 302 or the external memory 311 also stores an operating system (hereinafter referred to as “OS”), various programs that are required to implement functions executed by respective apparatus and that are described later, and the like. The RAM 303 functions as a main memory of the CPU 301, a work area, and the like.

The CPU 301 implements various types of operation by loading a program and the like that are required to execute processing onto the RAM 303 and running the program.

An input controller (input controlling unit) 305 controls input from a keyboard (KB) 309 and from a pointing device that is a mouse or the like (not shown).

A video controller (VC) 306 controls display on a CRT display (CRT) 310 or another display device. The display device is not limited to CRT and may be a liquid crystal display. Those are used by an administrator as required.

A memory controller (MC) 307 controls access to the external memory 311 storing a boot program, browser software, various applications, font data, a user file, an editing file, various types of data, and the like. The external memory 311 is, for example, a hard disk (HD) drive or a floppy disk (FD, trademark), or a card-type memory connected to a PCMCIA card slot via an adapter, or the like.

A communication I/F controller (communication I/F controlling unit) 308 connects and communicates to/from an external device via a network so as to execute network-based communication controlling processing. For example, Internet communication using TCP/IP or the like can be performed.

The CPU 301 performs deploying (rasterizing) processing of outline fonts in a display information area in the RAM 303 so as to enable display on the CRT 310. In addition, the CPU 301 enables the user to designate a position on the CRT 310 by a mouse cursor (not shown) or the like.

Various programs and the like that are used in order for the genuine product determining server 200 of this embodiment to execute various types of processing described later are recorded in the external memory 311, and are loaded onto the RAM 303 as required, to be run by the CPU 301. Definition files and various information tables used by programs according to the present invention are further stored in the external memory 311.

[Configuration of Box]

FIG. 4 is a diagram for illustrating an example of a utilization mode of the genuine product determination in the first embodiment.

An unopened state 410 of the box 400 is described first.

The box 400 represents a box containing a commercial product (not shown). The tamper evident seal 401 or the tamper evident seal 402 is stuck to a part of the box 400 at which the box 400 is to be opened. Under this state, the portable terminal 100 reads a radio frequency identification (RFID) chip. The portable terminal 100 alternatively reads a two-dimensional code.

When a lid of the box is opened, the tamper evident seal 401 is broken and the RFID chip (including an antenna) is damaged, with the result that the RFID chip of the tamper evident seal 401 is unreadable. That is, once the box is opened and the tamper evident seal is broken, the genuine product determination using RFID cannot be executed. Similarly, opening of the box breaks the tamper evident seal bearing a two-dimensional code and renders the tamper evident seal difficult to read.

In order to ensure that the tamper evident seals are easily broken by opening the box, a configuration in which the tamper evident seals have a plurality of cuts along their perimeters is desirable, but the tamper evident seals are not limited thereto.

No other tamper evident seals manufactured share the same identification information as that of the tamper evident seal 401, and the same identification information is therefore not read once the box is opened. However, when a person with a malicious intent manufactures an illegitimate tamper evident seal (a copied tamper evident seal), a tamper evident seal having the same identification information may be read. It is therefore particularly effective in genuine product determination to determine that a product bearing identification information that has been read a plurality of times may be a non-genuine product, and notifies the user of the possibility.

A structure 411 of the tamper evident seal 401 is illustrated. The tamper evident seal 401 is configured from, for example, a separating material, an adhesive material, a base material, an antenna, a chip, another adhesive material, and a surface material. The separating material is peeled off to stick the tamper evident seal 401 to the box 400.

The structure allows reading of identification information inside the chip via the antenna by connecting the chip and the antenna. The identification information obtained from the RFID chip is, for example, an Electronic Product Code (EPC)-based information or a ucode-based information. The tamper evident seal 401 is stuck to the box 400 by the adhesive material, with the separating material peeled off. The tamper evident seal 401 is structured so as to be torn from a cut created in the tamper evident seal when the tamper evident seal is to be peeled off from the box, and the structure accordingly makes it difficult to reuse a peeled seal.

The chip may be a chip using a Physical Unclonable Function (PUF) technology.

An opened state 420 of the box 400 is described.

The opened state 420 is a state in which the lid of the box 400 is opened and the tamper evident seal 401 or 402 is broken.

Although an example in which a tamper evident seal has one of an RFID chip and a two-dimensional code is illustrated in FIG. 4, an embodiment in which a serial code (identification information) is printed on a tamper evident seal and the user manually inputs the serial code to the portable terminal 100 to execute genuine product determination may be carried out.

[Function Configuration]

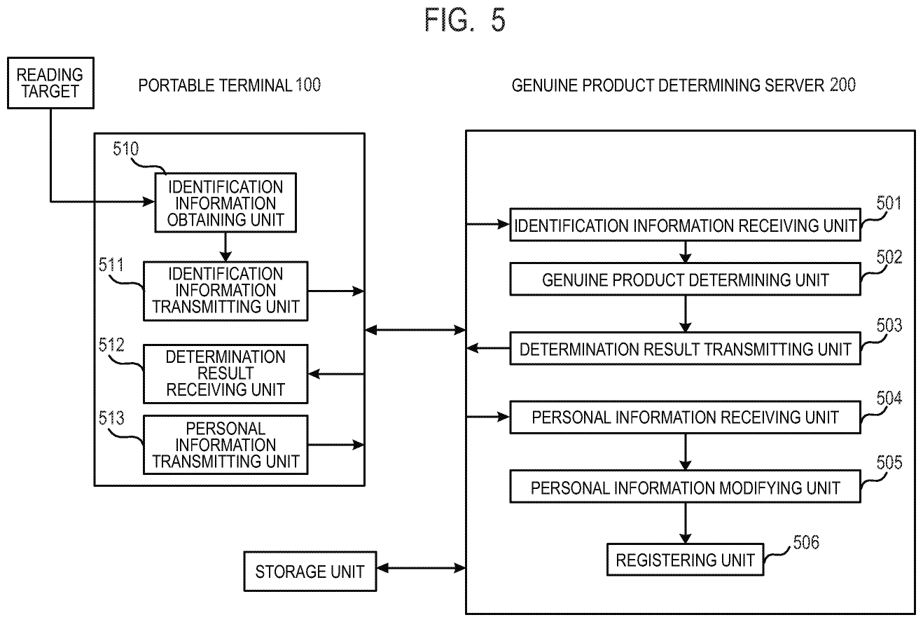

FIG. 5 is a diagram for illustrating an example of a function configuration in the first embodiment. The genuine product determining server 200 includes an identification information receiving unit 501, a genuine product determining unit 502, a determination result transmitting unit 503, a personal information receiving unit 504, a personal information modifying unit 505, and a registering unit 506. Those function units are executed by the CPU 301. The portable terminal 100 includes an identification information obtaining unit 510, an identification information transmitting unit 511, a determination result receiving unit 512, and a personal information transmitting unit 513. Those function units are executed by the processor 29.

The identification information obtaining unit 510 is a function unit which obtains identification information used to determine whether a product is a genuine product. The identification information obtaining unit 510 may obtain the identification information from the two-dimensional code recognizing unit 31, or from the RFID information obtaining unit 32. The identification information obtaining unit 510 may also obtain a serial code (identification information) input on a screen displayed on the display unit 24. The identification information obtaining unit 510 outputs the obtained identification information to the identification information transmitting unit 511.

The identification information transmitting unit 511 is a function unit which transmits the identification information obtained by the identification information obtaining unit 510 to the genuine product determining server 200 to request genuine product determination. The identification information transmitting unit 511 transmits the identification information to the genuine product determining server 200 in response to an instruction from the user of the portable terminal 100.

The determination result receiving unit 512 is a function unit which receives, from the genuine product determining server 200, a result of genuine product determination using the identification information transmitted by the identification information transmitting unit 511. The determination result received by the determination result receiving unit 512 indicates one of a determination that the product is a genuine product, a determination that the product is a non-genuine product, and a determination that the product may be a non-genuine product.

The personal information transmitting unit 513 is a function unit which transmits, to the genuine product determining server 200, personal information about the user of the portable terminal 100, for example, an IP address of the portable terminal 100 and position information indicating the current location of the portable terminal 100. The personal information transmitting unit 513 obtains the personal information (the IP address of the portable terminal 100, position information indicating the current location of the portable terminal 100, and the like) after the determination result received by the determination result receiving unit 512 is displayed on the display unit 24. The personal information transmitting unit 513 transmits the obtained personal information, the determination result received by the determination result receiving unit 512, and the identification information transmitted by the identification information transmitting unit 511 to the genuine product determining server 200.

The identification information receiving unit 501 is a function unit which receives and obtains the identification information transmitted by the identification information transmitting unit 511. The identification information receiving unit 501 outputs the received identification information to the genuine product determining unit 502. The identification information receiving unit 501 thus corresponds to an example of a first obtaining unit which obtains identification information about a product from the terminal apparatus.

The genuine product determining unit 502 is a function unit which uses the identification information received by the identification information receiving unit 501 to determine whether the product associated with the identification information is a genuine product. The genuine product determining unit 502 refers to an RFID table 810 or a two-dimensional code table 820 (genuine product information) in which identification information about a genuine product is registered, and determines the associated product to be a non-genuine product when the received identification information is registered in neither of those tables. The genuine product determining unit 502 determines the associated product to be a genuine product when the received identification information is registered in any one of those tables and the number of times determination using the received identification information has been executed is less than a predetermined count, and otherwise determines that the associated product may be a non-genuine product. The genuine product determining unit 502 outputs this determination result to the determination result transmitting unit 503. The genuine product determining unit 502 thus corresponds to an example of a determining unit which determines whether obtained identification information is included in genuine product information including identification information about a genuine product.

The determination result transmitting unit 503 is a function unit which transmits a determination result output as a result of the determination by the genuine product determining unit 502 to the portable terminal 100 that has requested the determination. The determination result transmitting unit 503 thus corresponds to an example of a transmitting unit which transmits a determination result to the terminal apparatus.

The personal information receiving unit 504 is a function unit which receives and obtains the personal information, the determination result, and the identification information that have been transmitted from the portable terminal 100. The personal information receiving unit 504 outputs the received pieces of information to the personal information modifying unit 505. The personal information receiving unit 504 thus corresponds to an example of a second obtaining unit which obtains, from the terminal apparatus, personal information from which a user of the terminal apparatus is identifiable.

The personal information modifying unit 505 is a function unit which modifies a part of the personal information received by the personal information receiving unit 504 so that the user of the portable terminal 100 is unidentifiable from the personal information. In a case of modifying the IP address, the personal information modifying unit 505 substitutes a predetermined octet in the IP address with a predetermined numerical value. In a case of modifying the position information, the personal information modifying unit 505 decreases the number of significant digits of the position information. The personal information is abstracted in this manner, to thereby ensure that the user of the portable terminal 100 is unidentifiable from the personal information (anonymized) and prepare personal information collected on the genuine product determining server 200 for use in a market study and the like as well. The personal information modifying unit 505 then outputs the modified (anonymized) personal information, the determination result, and the identification information to the registering unit 506. The personal information modifying unit 505 thus corresponds to an example of a modifying unit which modifies a part of the obtained personal information so that the user is not identified from the personal information. In other words, the personal information modifying unit 505 corresponds to an example of an anonymizing unit which anonymizes the obtained personal information.

The registering unit 506 is a function unit which registers the personal information modified by the personal information modifying unit 505 and the determination result and the identification information that have been received by the personal information receiving unit 504 in association with each other in history information. In this manner, who have requested the determination on what product and where the request has been issued can be retained as history. The registering unit 506 thus corresponds to an example of a registering unit which registers the obtained identification information, the determination result output as a result of the determination, and the modified personal information in association with each other in the storage unit. In other words, the registering unit 506 corresponds to an example of the registering unit which registers the obtained identification information, the determination result output as a result of the determination, and the anonymized personal information in the storage unit so that the determination result and the anonymized personal information are associated with the obtained identification information.

[Processing Flow]

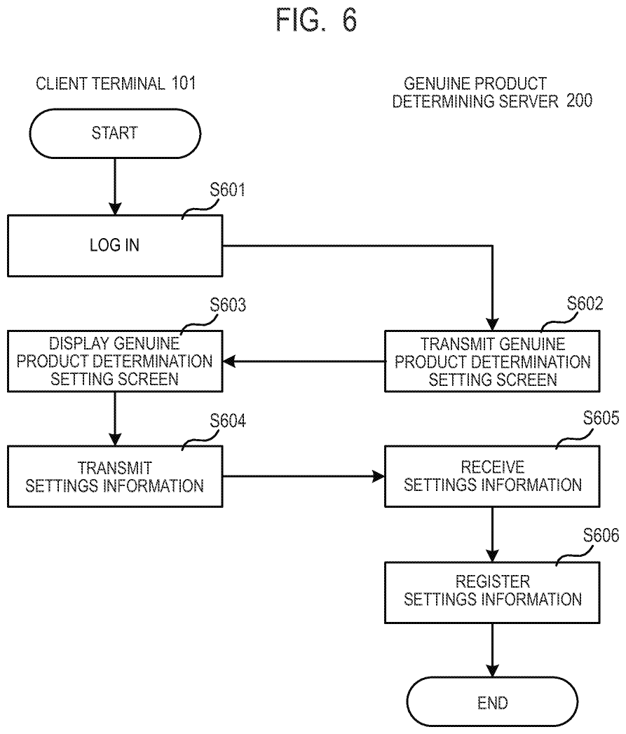

A flow of processing in the first embodiment is described next with reference to FIG. 6 to FIG. 9. First, a flow of steps to be executed when an administrator using a genuine product determining service on the genuine product determining server 200 sets various settings is described.

FIG. 6 is a diagram for illustrating an example of a flow of setting processing in the first embodiment.

In Step S601, the CPU 301 of the client terminal 101 accesses the genuine product determining server 200. The CPU 301 of the genuine product determining server 200 executes user authentication and then login processing. In Step S602, the CPU 301 of the genuine product determining server 200 transmits a genuine product determining condition setting screen to the client terminal 101 as a result of the login processing.

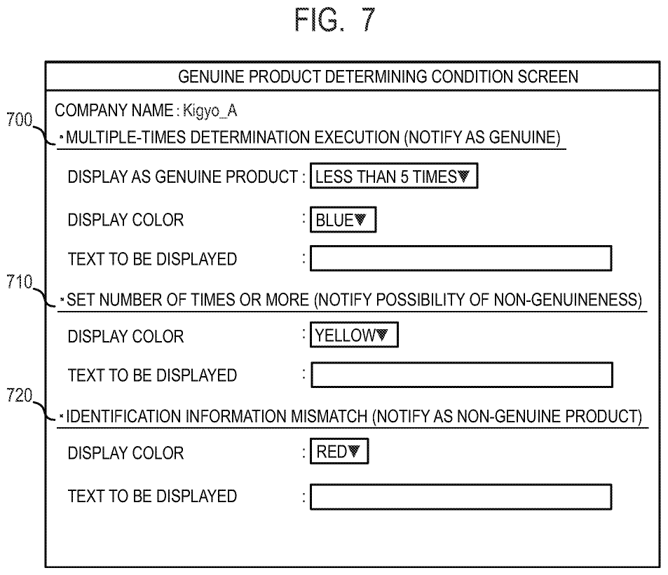

In Step S603, the CPU 301 of the client terminal 101 displays the genuine product determining condition setting screen as the one illustrated in FIG. 7 to receive input of various settings. The genuine product determining condition setting screen is received from the genuine product determining server 200 and is displayed by the client terminal 101 on the CRT 310.

The genuine product determining condition setting screen of FIG. 7 is described. The genuine product determining condition setting screen is a screen including multiple-times determination execution (notify as genuine) 700, a set number of times or more (notify possibility of non-genuineness) 710, and identification information mismatch (notify as non-genuine product) 720.

The multiple-times determination execution (notify as genuine) 700 is an item for setting the number of times determination is to be executed when a product is notified as genuine. A case in which the multiple-times determination execution (notify as genuine) 700 is set to “less than five times” is described as an example. When the number of times determination using identification information of the same tamper evident seal has been executed is less than five times, a result indicating that the product is genuine is notified to the relevant portable terminal 100. For the multiple-times determination execution (notify as genuine) 700, any display color and any text to be displayed can be set to be used on a determination result screen. Exclusion control is executed for the display color in order to avoid overlapping use with another item.

The set number of times or more (notify possibility of non-genuineness) 710 is a setting item for a case of notifying a possibility of being a non-genuine product. In the case of the set number of times or more (notify possibility of non-genuineness) 710, a condition for notifying as non-genuine is a number of times equal to or more than the number of times set to the multiple-times determination execution (notify as genuine) 700. For example, when “less than five times” is set to the multiple-times determination execution (notify as genuine) 700, a result indicating that the product may be non-genuine is notified to the relevant portable terminal 100 once the number of times the determination has been executed reaches five times or more. For the set number of times or more (notify possibility of non-genuineness) 710, any display color and any text to be displayed can be set to be used on a determination result screen. Exclusion control is executed for the display color in order to avoid overlapping use with another item.

The identification information mismatch (notify as non-genuine product) 720 is a setting item for a case in which the product is to be notified as non-genuine when the obtained identification information is not included in the genuine product information. For the identification information mismatch (notify as non-genuine product) 720, any display color and any text to be displayed can be set to be used on the determination result screen. Exclusion control is executed for the display color in order to avoid overlapping use with another item.

Those settings may be set for each company that uses the genuine product determining service on the genuine product determining server 200, or may be set for each product on which the genuine product determination is performed. For example, different settings may be applied to Company A and Company B, or different settings may be applied to Product A and Product B of Company A.

The description returns to FIG. 6. In Step S604, the CPU 301 of the client terminal 101 transmits settings information set on the genuine product determining condition setting screen of FIG. 7 to the genuine product determining server 200. In Step S605, the CPU 301 of the genuine product determining server 200 receives the settings information. In Step S606, the CPU 301 of the genuine product determining server 200 registers the received settings information in the external memory 311. An example of the registered settings information is settings information 800 of FIG. 8.

The settings information 800 is described. The settings information 800 is settings information referred to by the genuine product determining server 200. Conditions and values set in fields for the multiple-times determination execution (notify as genuine) 700, the set number of times or more (notify possibility of non-genuineness) 710, and the identification information mismatch (notify as non-genuine product) 720 on the genuine product determining condition setting screen are registered as genuine product determining conditions on a company-by-company basis.

A flow of steps of the genuine product determining service on the genuine product determining server 200 is described next.

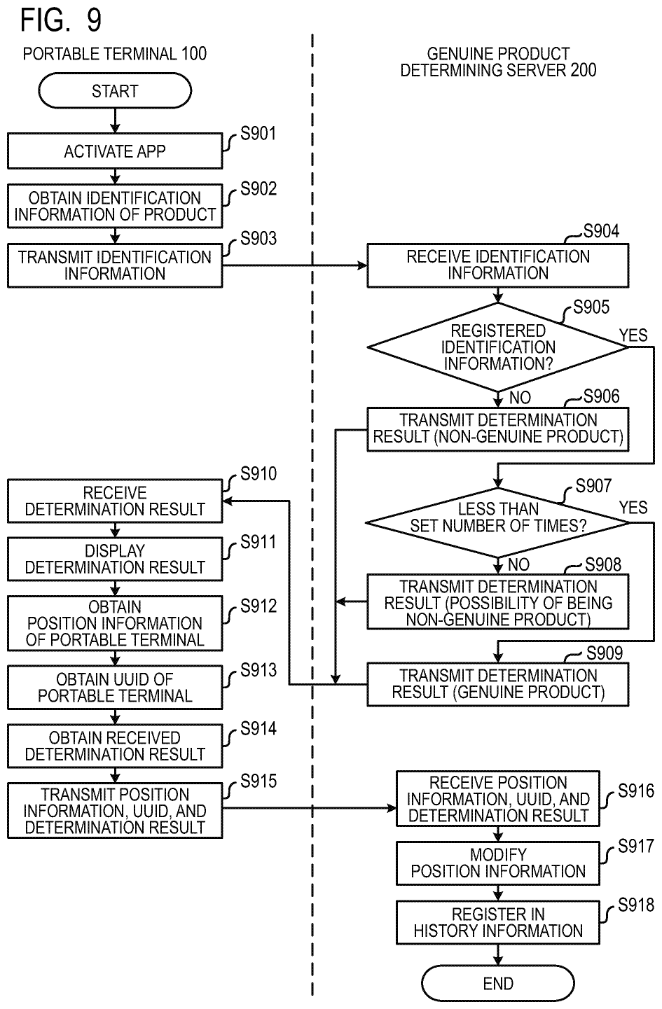

FIG. 9 is a diagram for illustrating an example of a flow of genuine product determining processing in the first embodiment.

In Step S901, the processor 29 of the portable terminal 100 activates an application stored in the storage unit 28. This application is an application for using the genuine product determining service. A user of the portable terminal 100 installs this application in the portable terminal 100 in advance. In the following description, steps illustrated in FIG. 9 as steps executed on the portable terminal 100 are implemented through operation performed by pieces of hardware and function units of the portable terminal 100 in accordance with instructions from this application.

In Step S902, the identification information obtaining unit 510 of the portable terminal 100 obtains identification information about a product that is a target of the genuine product determination (hereinafter referred to as “target product”). As described above, the identification information obtaining unit 510 may obtain the identification information from a two-dimensional code or from an RFID chip. Further, the identification information obtaining unit 510 may obtain identification information input on a screen.

In Step S903, the identification information transmitting unit 511 of the portable terminal 100 transmits the identification information obtained in Step S902 to the genuine product determining server 200. That is, the identification information transmitting unit 511 requests the genuine product determining server 200 to execute the genuine product determination using this identification information.

In Step S904, the identification information receiving unit 501 of the genuine product determining server 200 receives the identification information transmitted in Step S903.

In Step S905, the genuine product determining unit 502 of the genuine product determining server 200 determines whether the identification information received in Step S904 is identification information registered in advance. Identification information of a genuine product is registered in the external memory 311 of the genuine product determining server 200 in advance as the genuine product information. An RFID table 810 and a two-dimensional code table 820 of FIG. 8 are an example of the genuine product information. Identification information recorded in an RFID chip is registered in the RFID table 810. Identification information recorded in a two-dimensional code is registered in the two-dimensional code table 820. Similarly, identification information manually input to the portable terminal 100 (the serial code described above) is required to be registered as the genuine product information in advance, although not shown in FIG. 8. Whether the identification information received in Step S904 is included in those pieces of genuine product information is determined. When it is determined that the identification information is registered identification information, the process proceeds to Step S907. When it is determined that the identification information is not registered identification information, the process proceeds to Step S906.

In Step S906, the genuine product determining unit 502 of the genuine product determining server 200 outputs a determination result indicating that the target product is a non-genuine product. The determination result transmitting unit 503 of the genuine product determining server 200 transmits the output determination result to the portable terminal 100 that has requested the genuine product determination. When a display color and text to be displayed are set in the settings information 800, the determination result transmitting unit 503 transmits information about the display color and the text to be displayed that are to be used when the genuine product determining condition is “mismatch”, along with the determination result.

In Step S907, the genuine product determining unit 502 of the genuine product determining server 200 first refers to history information 830 stored in the external memory 311. An example of the history information 830 is illustrated in FIG. 8. The history information 830 is information indicating history of execution of the genuine product determination. The history information 830 includes identification information 831, a determination count 832, position information 833, a UUID 834, an IP address 835, and a determination result 836. The data items included in the history information 830 illustrated in FIG. 8 are just an example, and the history information 830 may include data items other than those. The identification information 831 indicates identification information for which the genuine product determination has been executed. The determination count 832 indicates the number of times the genuine product determination has been executed. The position information 833 indicates the current location of the portable terminal 100 that has requested the genuine product determination. The UUID 834 indicates a universally unique identifier (UUID) for identifying an application that has requested the genuine product determination. The IP address 835 indicates an IP address of the portable terminal 100 that has requested the genuine product determination. The IP address is desired to be a global IP address. The determination result 836 indicates a result of the genuine product determination by the genuine product determining server 200.

The genuine product determining unit 502 of the genuine product determining server 200 then refers to the settings information 800 registered in advance as well, and determines whether a determination count that is the number of times the determination has been executed with the use of the identification information received in Step S904 is equal to or less than a set count. The determining condition may be set to “equal to or less than a set count” instead of “less than a set count.” The set count is recorded in the settings information 800. The settings information 800 of a company related to the target product is obtained and a set count recorded in this settings information is used in the determination. The determination count is recorded in the history information 830. That is, the determination count 832 of the identification information 831 that matches the identification information received in Step S904 is used.

For example, the set count is “5 times” in the settings information 800 of FIG. 8, and the genuine product determining unit 502 accordingly determines whether a determination count that is the number of times the determination has been executed with the use of the identification information received in Step S904 is less than five times. When it is determined as a result of the determination in Step S907 that the determination count is less than the set count, the process proceeds to Step S909. When it is determined that the determination count is not less than the set count, that is, the determination count is equal to or more than the set count, the process proceeds to Step S908.

In Step S908, the genuine product determining unit 502 of the genuine product determining server 200 outputs a determination result indicating that the target product may be a non-genuine product. The determination result transmitting unit 503 of the genuine product determining server 200 transmits the output determination result to the portable terminal 100 that has requested the genuine product determination. When a display color and text to be displayed are set in the settings information 800, the determination result transmitting unit 503 transmits information about the display color and the text to be displayed that are to be used when the genuine product determining condition is “the set count or more”, along with the determination result.

In Step S909, the genuine product determining unit 502 of the genuine product determining server 200 outputs a determination result indicating that the target product is a genuine product. The determination result transmitting unit 503 of the genuine product determining server 200 transmits the output determination result to the portable terminal 100 that has requested the genuine product determination. When a display color and text to be displayed are set in the settings information 800, the determination result transmitting unit 503 transmits information about the display color and the text to be displayed that are to be used when the genuine product determining condition is “less than the set count,” along with the determination result.

In Step S910, the determination result receiving unit 512 of the portable terminal 100 receives the determination result transmitted from the genuine product determining server 200. The determination result received by the determination result receiving unit 512 in Step S910 is the determination result transmitted in one of Step S906, Step S908, and Step S909. When there is also information about the display color and the text to be displayed that has been transmitted from the genuine product determining server 200, the information about those is received as well.

In Step S911, the processor 29 of the portable terminal 100 displays the determination result received in Step S910 on the display unit 24. When the determination result indicates a genuine product, the processor 29 displays a screen notifying that the target product is a genuine product on the display unit 24. When the determination result indicates a non-genuine product, the processor 29 displays a screen notifying that the target product is a non-genuine product on the display unit 24. When the determination result indicates a possibility of being a non-genuine product, the processor 29 displays a screen notifying that the target product may be a non-genuine product on the display unit 24. The processor 29 changes a color of the screen to the received display color and displays the received text to be displayed on the screen when there is information about the display color and the text to be displayed that has been received in Step S910 along with the determination result. The determination result may be displayed on the display unit 24 by a display controlling unit (not shown) instead of the processor 29.

In Step S912, the GPS controlling unit 40 of the portable terminal 100 obtains the position information indicating the current location of the portable terminal 100. The position information is values indicating a latitude and a longitude of the portable terminal 100. In the first embodiment, the position information is real numbers each with six decimal places.

In Step S913, the processor 29 of the portable terminal 100 obtains a UUID of the application. A UUID is an identifier for uniquely identifying an application installed in the portable terminal 100. A new UUID is generated each time an application is installed in a portable terminal 100. That is, the UUID is an identifier for identifying an installed application. This is used as information for identifying the portable terminal 100. For such a purpose, it is common to obtain International Mobile Equipment Identity (IMEI). However, IMEI is an identification number assigned to the portable terminal 100, and is therefore highly likely to qualify as personal information. Accordingly, UUID is used as a substitute for IMEI.

In Step S914, the processor 29 of the portable terminal 100 obtains the determination result received in Step S910. In the first embodiment, the series of processing steps in which the genuine product determining server 200 executes the genuine product determination and a series of processing steps in which history registration described later is executed are not linked. That is, the series of processing steps of executing history registration is not configured so that a result of the genuine product determination is received. The determination result to be registered in the history information is therefore required to be transmitted from the portable terminal 100. This is why the received determination result is obtained in Step S914. The obtainment and transmission of the determination result is unrequired when the above-mentioned two series of processing steps are linked.

In Step S915, the personal information transmitting unit 513 of the portable terminal 100 transmits the identification information obtained in Step S902 and the position information, the UUID, and the determination result that have been obtained in Step S912 to Step S914 to the genuine product determining server 200. Desired timing of executing Step S915 is after completion of the display of the determination result in Step S911. The determination result transmitted by the genuine product determining server 200 may not reach the portable terminal 100 due to a communication error or the like, or may not be displayed due to a trouble on the portable terminal 100. In this case, the user of the portable terminal 100 may transmit the identification information to the genuine product determining server 200 again in order to instruct the genuine product determining server 200 to execute the genuine product determination once more. That is, there is a possibility that the same determination is executed a plurality of times due to an error or a trouble. Unrequired entries of history are consequently registered in the genuine product determining server 200. In particular, when determination results that are not meant to be counted are counted, the determination in Step S907 cannot be executed correctly. It is therefore desired to execute Step S915 after the determination result is displayed. Further, Step S915 is desired to be executed after the processor 29 determines whether the determination result has been displayed on the display unit 24 and determines that the determination result has been displayed.

In the first embodiment, the information described above is transmitted in Step S915. The transmitted information may include other types of information required by a company that uses the genuine product determining service. For example, the type of an OS of the portable terminal 100, the version of the OS, and a model name of the portable terminal 100 may be included.

In Step S916, the personal information receiving unit 504 of the genuine product determining server 200 receives and obtains the identification information, the position information, the UUID, and the determination result that have been transmitted from the portable terminal 100.

In Step S917, the personal information modifying unit 505 of the genuine product determining server 200 modifies the position information received in Step S916. In the first embodiment, the personal information modifying unit 505 rounds values of the latitude and the longitude that indicate the position information down to two decimal places (removes the third and subsequent decimal digits). For example, when the latitude and the longitude that are indicated by the received position information are “35.625683, 139.739905”, the personal information modifying unit 505 rounds the values down to two decimal places, with the result that “35.62, 139.73” is obtained. Identification of an individual from the position information is thus prevented (the position information is anonymized) by lowering precision of the position information, which qualifies as personal information. Although the latitude and the longitude are rounded down to two decimal places in the first embodiment, the present invention is not limited thereto as long as modification prevents identification of an individual. For example, the position information may be rounded down to one decimal place or three decimal places, or may be substituted with random values in the third and subsequent decimal places.

In Step S918, the registering unit 506 of the genuine product determining server 200 registers the position information modified in Step S917 and the identification information, the UUID, and the determination result that have been obtained in Step S916 in association with each other in the history information 830. When the history information 830 does not include the identification information 831 that matches the identification information about to be registered, the registering unit 506 creates a new record in the history information 830, and registers “1” in the determination count 832. The registering unit 506 then registers the obtained identification information, the modified position information, the obtained UUID, and the obtained determination result in the identification information 831, the position information 833, the UUID 834, and the determination result 836, respectively. When the history information 830 includes the identification information 831 that matches the identification information about to be registered, on the other hand, the registering unit 506 adds 1 to the determination count 832 in a record holding that identification information 831. The registering unit 506 then additionally registers the modified position information, the obtained UUID, and the obtained determination result in this record. A company that is a user of the genuine product determining service can grasp identification information about which a result of the genuine product determination has been displayed and a general location at which the result has been displayed, by referring to the various types of information registered in the history information 830. The company can also grasp whether genuine product determination using that identification information has been executed a plurality of times and, when the genuine product determination is found out to have been executed a plurality of times, whether the same application has requested the genuine product determination. The genuine product determining server 200 may create, for example, a screen on which determination history entries including personal information that is registered in the history information 830 can be displayed in a list format and may provide the screen to the company in order for the company to refer to the history information 830. This corresponds to an example of a screen generating unit which generates a screen capable of displaying a list of registered pieces of personal information.

As described above, when registering a result of the genuine product determination and personal information in the history information, the genuine product determining server modifies a part of the personal information prior to registration. This lightens the burden of managing personal information on an administrator of the genuine product determining server. This also enables a company that uses the genuine product determining service to refer to the history information.

### Modification Example 1-1

In the first embodiment, an application installed in the portable terminal 100 obtains identification information. Alternatively, a mode in which a Web browser installed in the portable terminal 100 obtains identification information may be employed.

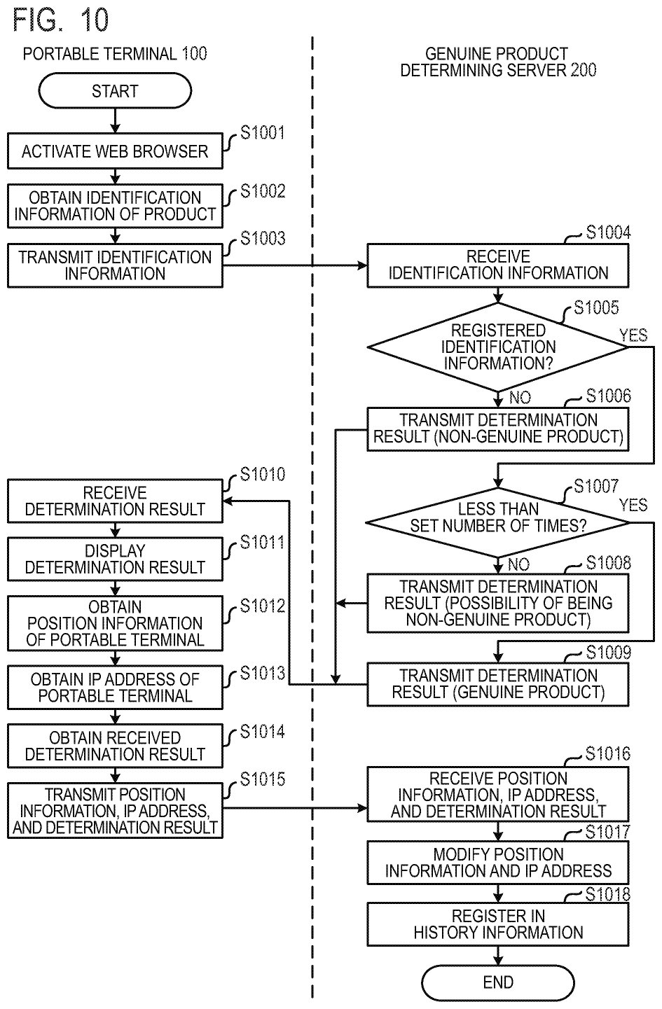

FIG. 10 is a modification example of the flow chart illustrated in FIG. 9. First, in Step S1001, the processor 29 of the portable terminal 100 activates a Web browser stored in the storage unit 28. This Web browser can be any Web browser capable of reading and executing HyperText Markup Language (HTML), JavaScript (trademark), and the like. The Web browser then accesses a Uniform Resource Locator (URL) input by a user of the portable terminal 100 as a URL of a Web page on which the genuine product determining service can be used.

A mode in which the portable terminal 100 reads a two-dimensional code and the Web browser accesses a URL included in the two-dimensional code may also be employed. The URL included in the two-dimensional code may include identification information about a target product. In this case, the genuine product determination is executed on the genuine product determining server 200 with the use of the identification information included in the URL, by accessing the URL. In the following description, steps illustrated in FIG. 10 as steps executed on the portable terminal 100 are implemented through operation performed by pieces of hardware and function units of the portable terminal 100 in accordance with instructions from this Web browser.

In Step S1002, the identification information obtaining unit 510 of the portable terminal 100 obtains identification information about a target product. In the modification example, the user inputs identification information that is printed on a printed material attached to a target product in an input form of a Web page displayed on the Web browser, and the identification information obtaining unit 510 obtains this identification information.

Steps from Step S1003 to Step S1012 are the same as Step S903 to Step S912 described above with reference to FIG. 9, and descriptions thereof are therefore omitted. In Step S1011, the determination result is displayed on a Web page. Whether the determination result has been displayed is determined from a script {JavaScript (trademark) or the like} included in the Web page. When it is determined that the determination result has been displayed, the processor 29 executes Step S1012 and subsequent steps written in the script.

In Step S1013, the processor 29 of the portable terminal 100 obtains an IP address of the portable terminal 100. Although a UUID is obtained in the first embodiment in order to identify the portable terminal 100, an IP address is obtained instead of a UUID in Modification Example 1-1. As described above, the IP address is desired to be a global IP address.

Step S1014 is the same as Step S914 described above with reference to FIG. 9, and description thereof is therefore omitted.

In Step S1015, the personal information transmitting unit 513 of the portable terminal 100 transmits, to the genuine product determining server 200, the identification information obtained in Step S1002 and the position information, the IP address, and the determination result that have been obtained in Step S1012 to Step S1014.

In Step S1016, the personal information receiving unit 504 of the genuine product determining server 200 receives and obtains the identification information, the position information, the IP address, and the determination result that have been transmitted from the portable terminal 100.

In Step S1017, the personal information modifying unit 505 of the genuine product determining server 200 modifies the position information and the IP address that have been received in Step S1016. The position information is modified in the same manner as in the first embodiment. The IP address is modified by substituting a fourth octet out of octets that form the IP address with 0. For example, when the received IP address is “202.228.266.123,” the fourth octet is substituted with 0 to obtain “202.228.266.0.” The IP address is thus modified so that an individual is unidentifiable. The substitution is not limited to the fourth octet, and the third octet may be substituted with 0. The substitution may also be changed so that a numerical value other than 0 is used.

In Step S1018, the registering unit 506 of the genuine product determining server 200 registers the position information modified in Step S1017, the IP address modified in the same step, and the identification information and the determination result that have been obtained in Step S1016 in association with one another in the history information 830. When the history information 830 does not include the identification information 831 that matches the identification information about to be registered, the registering unit 506 creates a new record in the history information 830, and registers “1” in the determination count 832. The registering unit 506 then registers the obtained identification information, the modified position information, the modified IP address and the obtained determination result in the identification information 831, the position information 833, the IP address 835, and the determination result 836, respectively. When the history information 830 includes the identification information 831 that matches the identification information about to be registered, on the other hand, the registering unit 506 adds “1” to the determination count 832 in a record holding that identification information 831. The registering unit 506 then additionally registers the modified position information, the modified IP address, and the obtained determination result in this record.

The mode in which a Web browser is used to transmit identification information to the genuine product determining server 200, a result of the determination by the server is displayed on the Web browser, and personal information is transmitted from the Web browser may thus be employed.

### Modification Example 1-2

In the first embodiment and Modification Example 1-1, modification of personal information is executed by the genuine product determining server 200. However, a mode in which the portable terminal 100 modifies personal information and transmits the modified personal information to the genuine product determining server 200 may be employed. In this case, the personal information modifying unit 505 of the genuine product determining server 200 is included in the portable terminal 100. Before transmitting personal information to the genuine product determining server 200, the personal information modifying unit 505 of the portable terminal 100 anonymizes the personal information by modifying a part of the position information or a part of the IP address. The modified personal information is transmitted by the personal information transmitting unit 513 and is registered in the history information 830 by the registering unit 506 of the genuine product determining server 200. The same applies to a second embodiment and Modification Example 2-1 described later.

### Second Embodiment

A mode in which partial modification of personal information is executed when the current location of the portable terminal 100 is inside a predetermined region is described in the second embodiment. When a part of personal information is modified as in the first embodiment, a company that is a user of the genuine product determining service can obtain only abstract personal information. Laws and regulations regarding protection of personal information vary from country to country or from district to district, and personal information may be registered as it is without modification, depending on in which country or district the portable terminal 100 are located. This enables a company to analyze the history information with precision.

Accordingly, a mode in which whether modification of personal information is required is determined depending on the location of the portable terminal 100 that has transmitted identification information is described in the second embodiment.

The second embodiment is the same as the first embodiment except for the function configuration of FIG. 5, the genuine product determining condition setting screen illustrated in FIG. 7, the settings information 800 shown in FIG. 8, and the processing in the flow chart of FIG. 9, which belong to the first embodiment. The description here is therefore focused on differences from the first embodiment.

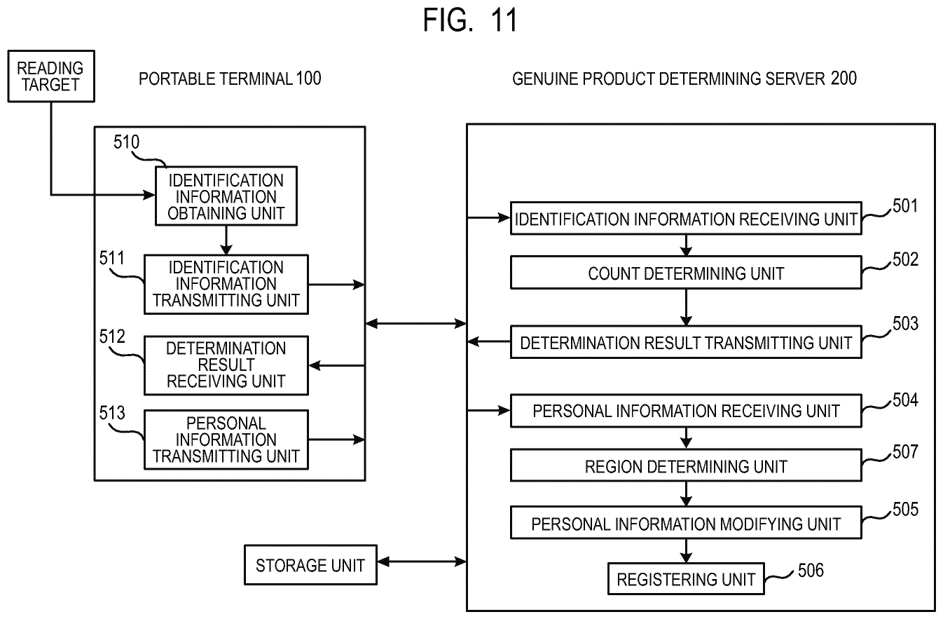

FIG. 11 is an example of a function configuration in the second embodiment. The genuine product determining server 200 further includes a region determining unit 507 in addition to the function configuration in the first embodiment.

The region determining unit 507 is a function unit which determines a place (region) in which the portable terminal 100 is located with the use of the position information of the portable terminal 100 which has been output from the personal information receiving unit 504. A region indicating a country or a district may be stored in advance for each country or district. The region determining unit 507 may identify a region including a latitude and a longitude that are indicated by the position information, out of stored regions, and then identify a country or a district that is associated with the identified region. An application programming interface (API) for determining a country or a district from position information is published on the Internet, and may be utilized here.

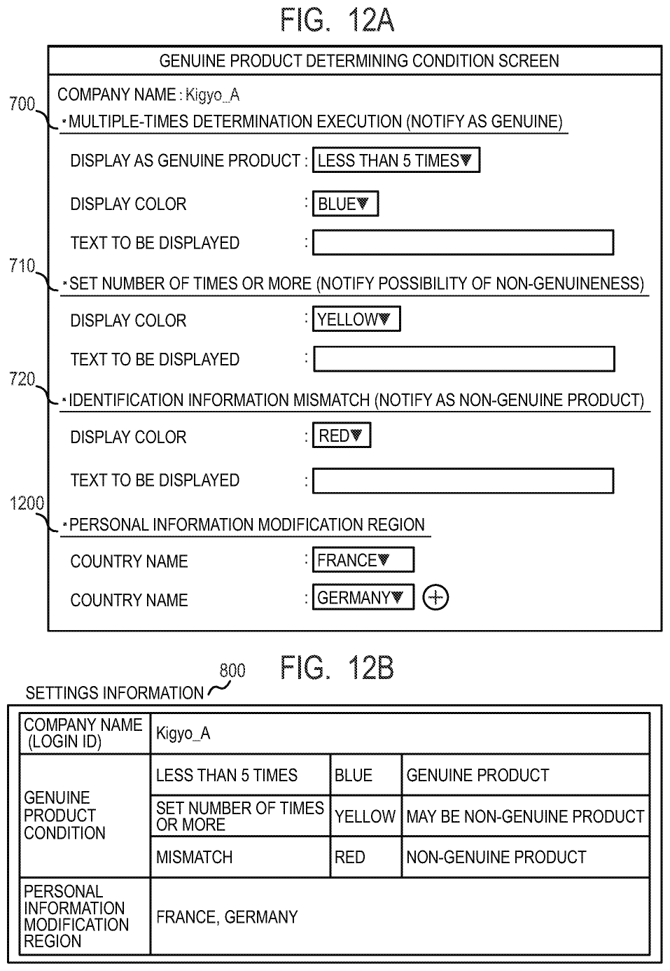

FIG. 12A is a diagram for illustrating an example of a genuine product determining condition setting screen in the second embodiment. The screen illustrated in FIG. 12A is obtained by adding a personal information modification region 1200, which is a setting item, to the genuine product determining condition setting screen in the first embodiment. A company using the genuine product determining service sets a country or a district for which a part of personal information is to be modified. When personal information is transmitted from the portable terminal 100 that is located in the set country or district, the personal information modifying unit 505 modifies a part of the personal information.

FIG. 12B is a table for illustrating an example of the settings information 800 in the second embodiment. Settings set on the genuine product determining condition setting screen of FIG. 12A are registered as shown in the settings information 800 of FIG. 12B. That is, a personal information modification region is further registered in addition to the settings information 800 in the first embodiment. As in the first embodiment, a personal information modification region may be set on a company-by-company basis, or the same country or district may be set as a personal information modification region for every company.

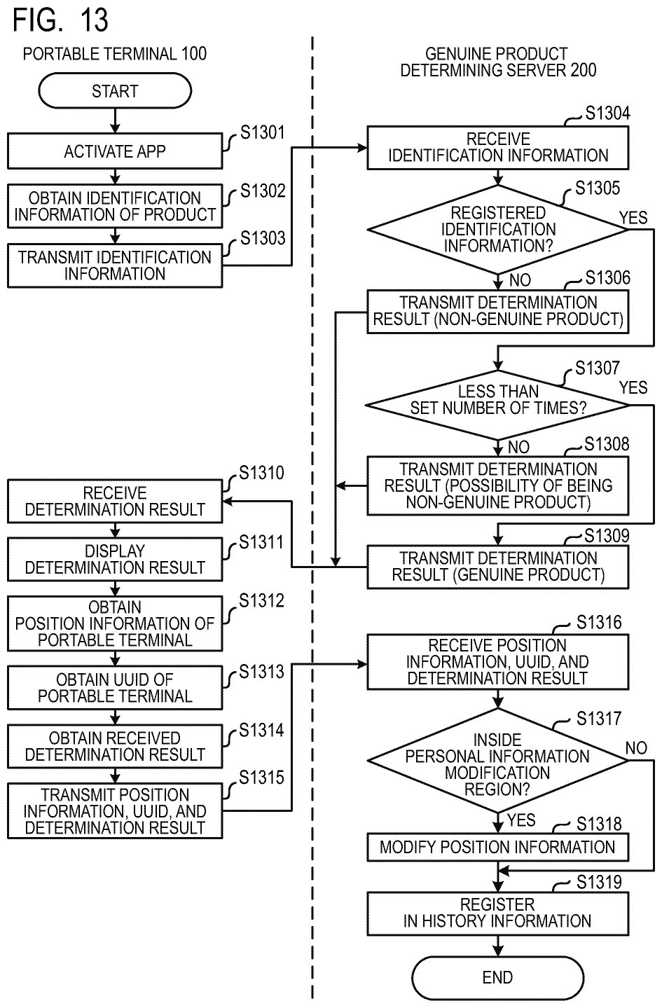

FIG. 13 is a diagram for illustrating an example of a flow of genuine product determining processing in the second embodiment. Differences from the first embodiment are the focus of description on the processing of FIG. 13 as well.

Steps from Step S1301 to Step S1316 are the same as Step S901 to Step S916 described above, and descriptions thereof are therefore omitted.

In Step S1317, the region determining unit 507 of the genuine product determining server 200 determines whether a position indicated by the position information obtained in Step S1316 is included in a personal information modification region registered in the settings information 800. First, the region determining unit 507 identifies a country or a district in which the portable terminal 100 is located from the obtained position information. The region determining unit 507 then determines whether the identified country or district is in a personal information modification region registered in the settings information 800. When it is determined that the portable terminal 100 is located inside the personal information modification region, the process proceeds to Step S1318. When it is determined that the portable terminal 100 is not located inside the personal information modification region, the process skips Step S1318 and proceeds to Step S1319.

Step S1318 is the same as Step S917 described above, and description thereof is therefore omitted. In Step S1319, the registering unit 506 of the genuine product determining server 200 registers the position information modified in Step S1318, or the unmodified position information, in the history information 830 in association with the identification information, the UUID, and the determination result that have been obtained in Step S1316.

In this manner, personal information obtained through the genuine product determination can be managed more flexibly.

### Modification Example 2-1

The determination of a personal information modification region is also applicable to the mode of Modification Example 1-1 in which a Web browser is used to transmit identification information to the genuine product determining server 200, a result of the determination by the server is displayed on the Web browser, and personal information is transmitted from the Web browser. The same processing step as Step S1317 of the second embodiment is inserted between Step S1016 and Step S1017 of FIG. 10. When it is determined that the portable terminal 100 is located inside the personal information modification region, the process proceeds to Step S1017. When it is determined that the portable terminal 100 is not located inside the personal information modification region, the process skips Step S1017 and proceeds to Step S1018. In this manner, the determination of a personal information modification region can be accomplished also in utilization of the genuine product determining service that uses a Web browser.

According to the embodiments and the modification examples described above, the burden of managing personal information that is obtained through determination about whether a product is genuine can be lightened.

### OTHER EMBODIMENTS

The embodiments are described above in detail, but the present invention may be embodied as, for example, a system, an apparatus, a method, a program, a storage medium, or the like. Specifically, the present invention may be adapted to a system that includes a plurality of devices, or an apparatus that includes a single device.

The present invention includes a case in which a software program that achieves the functions of the above-mentioned embodiments is supplied directly or remotely to a system or an apparatus. The present invention also includes a case in which the computer of the system or the apparatus reads out and executes the supplied program codes.

Therefore, the present invention is achieved by program codes themselves installed on the computer so that the computer achieves the functional processes of the present invention. That is, the present invention includes a computer program itself for achieving the functional processes of the present invention.

In this case, the computer program may take any of forms, such as an object code, a program which is executed by an interpreter, or script data to be supplied to the OS, as long as the program has program functions.

Storage media for supplying a program include a flexible disk, a hard disk, an optical disc, an MO, a CD-ROM, a CD-R, a CD-RW, and the like. The storage media further include a magnetic tape, a nonvolatile memory card, a ROM, and a DVD (DVD-ROM, DVD-R).

In addition, methods of supplying a program include a method of connecting to a webpage over the Internet using a browser installed on a client computer. Alternatively, the computer program according to the present invention may be supplied by downloading the computer program itself or a file having the computer program compressed and provided with an auto-install function from the webpage onto a recording medium, for example, a hard disk.

Further, the computer program according to the present invention may be achieved by dividing the program codes forming the program into a plurality of files and by downloading the files from different and respective webpages. That is, a WWW server that permits a plurality of users to download program files for achieving the functional processes of the present invention on a computer is also included in the scope of the present invention.

As an alternative method, the program according to the present invention may be encrypted and stored on storage media, for example, a CD-ROM, and distributed to users, and a certain user who clears predetermined conditions is permitted to download key information to decrypt the encrypted program from a webpage over the Internet. The user can use the downloaded key information to run the encrypted program to be installed on a computer to achieve the program of the present invention.

Further, a computer may execute the read-out program to achieve the functions of the above-mentioned embodiments. In addition, the OS or the like that is running on a computer may execute the actual processes partly or entirely based on instructions from the program, thereby achieving the functions of the above-mentioned embodiments.

As a further method, a program read out from a recording medium is written in a memory provided on a function expansion board mounted on a computer, or a function expansion unit connected to a computer. Then, a CPU or the like mounted on the function expansion board or the function expansion unit executes the actual processes partly or entirely based on instructions from the program, thereby achieving the functions of the above-mentioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A server apparatus comprising:
at least one memory and at least one processor which function as:
a first obtaining unit configured to obtain identification information about a product from a terminal apparatus;
a determining unit configured to determine whether the obtained identification information is included in genuine product information including identification information about a genuine product;
a second obtaining unit configured to obtain, from the terminal apparatus, personal information from which a user of the terminal apparatus is identifiable;
an anonymizing unit configured to anonymize the obtained personal information; and
a registering unit configured to register the obtained identification information, a determination result output as a result of the determination, and the anonymized personal information in a storage unit so that the determination result and the anonymized personal information are associated with the obtained identification information.

2. The server apparatus according to claim 1,
wherein the personal information includes an IP address of the terminal apparatus, and
wherein the anonymizing unit is configured to substitute a predetermined octet in the IP address with a predetermined numerical value.

3. The server apparatus according to claim 1,
wherein the second obtaining unit is configured to obtain, from the terminal apparatus, a UUID assigned to the terminal apparatus, and
wherein the registering unit is configured to register the obtained identification information, the determination result, the anonymized personal information, and the obtained UUID in the storage unit so that the obtained UUID is associated with the obtained identification information.

4. The server apparatus according to claim 1,
wherein the personal information includes position information indicating a current location of the terminal apparatus, and
wherein the anonymizing unit is configured to decrease a number of significant digits of the position information.

5. The server apparatus according to claim 1, wherein the identification information comprises at least one of information obtained from a two-dimensional code attached to the product, information obtained from a contactless tag attached to the product, or information printed on a printed material attached to the product.

6. The server apparatus according to claim 1, wherein the at least one memory and the at least one processor further function as a screen generating unit configured to generate a screen on which the registered personal information is displayable in a list format.

7. The server apparatus according to claim 1, wherein the anonymizing unit is configured to anonymize the obtained personal information when a current location of the terminal apparatus is inside a predetermined region.

8. The server apparatus according to claim 1, wherein the determining unit is configured to further determine whether the product associated with the obtained identification information is a genuine product based on a determination count that is a number of times of execution of the determination using the obtained identification information.

9. The server apparatus according to claim 1,
wherein the at least one memory and the at least one processor further function as a transmitting unit configured to transmit the determination result to the terminal apparatus,
wherein the personal information is information transmitted from the terminal apparatus after the transmitted determination result is displayed.

10. A method of controlling a server apparatus, the method comprising:
a first obtaining step of obtaining identification information about a product from a terminal apparatus;
a determining step of determining whether the obtained identification information is included in genuine product information including identification information about a genuine product;
a second obtaining step of obtaining, from the terminal apparatus, personal information from which a user of the terminal apparatus is identifiable;
an anonymizing step of anonymizing the obtained personal information; and
a registering step of registering the obtained identification information, a determination result output as a result of the determination, and the anonymized personal information in a storage unit so that the determination result and the anonymized personal information are associated with the obtained identification information.

11. A non-transitory computer-readable storage medium having stored thereon a program for causing, when executed by a computer, the computer to function as a server apparatus comprising:
at least one memory and at least one processor which function as:
a first obtaining unit configured to obtain identification information about a product from a terminal apparatus;
a determining unit configured to determine whether the obtained identification information is included in genuine product information including identification information about a genuine product;
a second obtaining unit configured to obtain, from the terminal apparatus, personal information from which a user of the terminal apparatus is identifiable;
an anonymizing unit configured to anonymize the obtained personal information; and
a registering unit configured to register the obtained identification information, a determination result output as a result of the determination, and the anonymized personal information in a storage unit so that the determination result and the anonymized personal information are associated with the obtained identification information.

12. An information processing system comprising:
at least one memory and at least one processor which function as:
a receiving unit configured to receive identification information about a product from a terminal apparatus;
an obtaining unit configured to obtain abstract information in which at least a part of specific information about a location or an address of the terminal apparatus is abstracted; and
a controlling unit configured to perform control so that the identification information received by the receiving unit and the abstract information obtained by the obtaining unit are stored in association with each other.

13. The information processing system according to claim 12,
wherein the at least one memory and the at least one processor further function as a processing unit configured to execute processing of abstracting at least a part of the specific information received from the terminal apparatus,
wherein the obtaining unit is configured to obtain, as the abstract information, information abstracted by the processing unit.

14. The information processing system according to claim 12, wherein the specific information comprises position information of the terminal apparatus.

15. The information processing system according to claim 14, wherein the abstract information comprises the position information decreased in a number of significant digits.

16. The information processing system according to claim 12, wherein the specific information comprises an IP address of the terminal apparatus.

17. The information processing system according to claim 16, wherein the abstract information comprises the IP address in which a predetermined octet is substituted with a predetermined numerical value.

18. The information processing system according to claim 12,
wherein the at least one memory and the at least one processor further function as a determining unit configured to determine whether the identification information received by the receiving unit is included in genuine product information including identification information about a genuine product,
wherein the controlling unit is configured to perform control so that the identification information received by the receiving unit, the abstract information obtained by the obtaining unit, and a determination result that is a result of the determination by the determining unit are stored in association with one another.

19. The information processing system according to claim 18, wherein the determining unit is configured to determine whether the product associated with the identification information received by the receiving unit is a genuine product based on a determination count that is a number of times of execution of the determination using the identification information received by the receiving unit.

20. The information processing system according to claim 18,
wherein the at least one memory and the at least one processor further function as a transmitting unit configured to transmit, to the terminal apparatus, information indicating a determination result of the determination by the determining unit,
wherein the obtaining unit is configured to obtain the abstract information based on the specific information transmitted from the terminal apparatus after display on the terminal apparatus that is based on the information indicating the determination result and transmitted from the transmitting unit.

21. The information processing system according to claim 12, wherein the identification information comprises at least one of information obtained from a two-dimensional code attached to the product, information obtained from a contactless tag attached to the product, or information printed on a printed material attached to the product.

22. The information processing system according to claim 12, wherein the at least one memory and the at least one processor further function as a generating unit configured to generate a screen on which the abstract information stored in association with the identification information under control by the controlling unit is displayable in a list format.

23. The information processing system according to claim 12,
wherein, when a current location of the terminal apparatus is inside a predetermined region, the controlling unit is configured to perform control so that the abstract information obtained by the obtaining unit is stored in association, and
wherein, when the current location of the terminal apparatus is outside the predetermined region, the controlling unit is configured to perform control so that the specific information without abstraction is stored in association.

24. A method of controlling an information processing system, the method comprising:
a receiving step of receiving identification information about a product from a terminal apparatus;
an obtaining step of obtaining abstract information in which at least a part of specific information about a location or an address of the terminal apparatus is abstracted; and
a controlling step of performing control so that the identification information received in the receiving step and the abstract information obtained in the obtaining step are stored in association with each other.

25. A non-transitory computer-readable storage medium having stored thereon a program for causing, when executed by a computer, the computer to function as an information processing apparatus comprising:
at least one memory and at least one processor which function as:
a receiving unit configured to receive identification information about a product from a terminal apparatus;
an obtaining unit configured to obtain abstract information in which at least a part of specific information about a location or an address of the terminal apparatus is abstracted; and
a controlling unit configured to perform control so that the identification information received by the receiving unit and the abstract information obtained by the obtaining unit are stored in association with each other.

26. A terminal apparatus comprising:
at least one memory and at least one processor which function as:
an obtaining unit configured to obtain identification information about a product;
an abstracting unit configured to abstract at least a part of specific information about a location or an address of the terminal apparatus;
a transmission controlling unit configured to perform control so that the identification information about the product obtained by the obtaining unit and information that is the specific information abstracted by the abstracting unit are transmitted to a specific communication destination; and
a display controlling unit configured to perform control so that display is executed based on information about the product that is received from the specific communication destination after the identification information is transmitted.

27. A method of controlling a terminal apparatus, the method comprising:
an obtaining step of obtaining identification information about a product;
an abstracting step of abstracting at least a part of specific information about a location or an address of the terminal apparatus;
a transmission controlling step of performing control so that the identification information about the product obtained in the obtaining step and information that is the specific information abstracted in the abstracting step are transmitted to a specific communication destination; and
a display controlling step of performing control so that display is executed based on information about the product that is received from the specific communication destination after the identification information is transmitted.

28. A non-transitory computer-readable storage medium having stored thereon a program for causing, the program, when executed by a computer, the computer to function as a terminal apparatus comprising:
at least one memory and at least one processor which function as:
an obtaining unit configured to obtain identification information about a product;
an abstracting unit configured to abstract at least a part of specific information about a location or an address of the terminal apparatus;
a transmission controlling unit configured to perform control so that the identification information about the product obtained by the obtaining unit and information that is the specific information abstracted by the abstracting unit are transmitted to a specific communication destination; and
a display controlling unit configured to perform control so that display is executed based on information about the product that is received from the specific communication destination after the identification information is transmitted.
